(19) United States
(12) Patent Application Publication
(10) Pub. No.: US 2008/0114506 A1
(43) Pub. Date: May 15, 2008

(54) HARD LANDING DETECTION

(76) Inventors: Christopher L. Davis, Maple Valley, WA (US); Jack S. Hagelin, Woodinville, WA (US); Jonathan R. LePere, Everett, WA (US); David P. Earle, Mukilteo, WA (US); Richard J. Reuter, Seattle, WA (US); Aydin Akdeniz, Redmond, WA (US); Eric D. Haugse, Seattle, WA (US); David M. Anderson, Sammamish, WA (US)

Correspondence Address: MACPHERSON KWOK CHEN & HEID, LLP, 2033 GATEWAY PLACE, SUITE 400, SAN JOSE, CA, 95110, US

(21) Appl. No.: 11/558,815

(22) Filed: Nov. 10, 2006

(51) Int. Cl. G06F 19/00

(52) U.S. Cl. 701/16

(57) ABSTRACT

A method and system for detecting a hard landing or other high load event of an aircraft are disclosed. A heuristic algorithm may be used to estimate loads experienced by the aircraft during landing. The heuristic algorithm may use flight parameters and/or measured sensor information to estimate the loads. The heuristic algorithm may be trained by means of analytical loads predictions and/or test measurements. The heuristic algorithm may be updated during operation. This invention may potentially reduce the number of unnecessary structural inspections, and may also limit the scope of any such required inspections.

### TECHNICAL FIELD

The present invention relates generally to aircraft maintenance and, more particularly, to a method and system for detecting hard or heavy aircraft landings.

### BACKGROUND

Hard or heavy landings are significant high load events that may adversely impact airframe structural integrity. Such landings may result in damage that affects the ability of the aircraft to fly safely. When this happens, repairs must be performed prior to flying the aircraft again. An inspection must be performed when there is a hard landing, so as to determine if such repairs are needed.

However, the inspection process that is required to assess the potential for damage due to a suspected hard landing event is undesirably time consuming. Further, the inspection process frequently results in a finding of no damage. Studies have shown that up to 90% of pilot initiated hard landing inspections resulted in no finding of damage.

Although pilots attempt to be realistic about the need for inspections, the fact that people's lives are at stake creates a strong bias in favor of safety. The results of performing unnecessary inspections include undesirably increased labor costs and lost revenues due to the down time of the aircraft.

In view of the foregoing, there is a need for a method and system for detecting hard aircraft landings that is not subject to human bias and thus provides a more realistic indication of the severity of the landing and the consequent need for inspection.

### SUMMARY

Systems and methods are disclosed herein for the detection of load inducing events in structures, such as hard landings of aircraft. For example, a heuristic algorithm may be used to estimate the severity of at least one load, generally a plurality of loads, experienced by an aircraft during landing.

More particularly, the heuristic algorithm may use at least one flight parameter to facilitate estimation of the loads(s). Generally, the heuristic algorithm may use a plurality of flight parameters, such as pitch angle, roll angle, roll rate, center of gravity (CG) vertical speed, vertical acceleration, airspeed, pilot seat acceleration, and air/ground indication to facilitate the estimation of the loads.

Further, information from at least one sensor may be used to facilitate estimation of the load(s). For example, information from strain gauges and/or accelerometers may be used by the heuristic algorithm to facilitate the estimation of the load(s).

The heuristic algorithm may be trained using results from an analytical ground loads simulation. The heuristic algorithm may be validated using flight test data. The heuristic algorithm may update itself using strains that are measured during operation of the aircraft.

The heuristic algorithm may be based upon neural networks, such as probabilistic neural networks trained with Bayesian regularization techniques. Sampled flight parameters and sensor data prior to and during the landing event may be processed by the heuristic algorithm to estimate the loads induced on the aircraft.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a high level overview of a hard landing detection system of the present invention in accordance with an exemplary embodiment of the present invention;

FIG. 2 shows a flow chart illustrating a method for detecting hard landings in accordance with an exemplary embodiment of the present invention; and

FIG. 3 shows a block diagram of a system for detecting hard landings in accordance with an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

According to contemporary practice, an attempt to fully characterize the loads applied to an aircraft during landing is performed by instrumenting the landing gear of the aircraft so as to obtain force measurements (e.g., via strain gauges). While this approach may be adequate in theory, the practical implementation of this technique presents logistical roadblocks, undesirably high costs, and reliability issues.

By way of contrast, an example of an embodiment of the present invention comprises methods and systems for detecting hard or heavy landings by using primarily kinematic information (i.e., displacement, velocity, accelerations, etc.). Thus, the need to instrument the aircraft is mitigated and costs are correspondingly decreased. One or more embodiments of the present invention may also use measured values based on instrumentation to further enhance accuracy.

One or more embodiments of the present invention comprises a hard landing detection method and system that provides information that aides substantially the maintenance process. A heuristic algorithm may use relevant aircraft flight parameters, as well as information from additional sensors, to predict pertinent loads critical to evaluation of damage due to a hard landing. By providing accurate and reliable load information, this system may significantly reduce the number of hours that an airplane is grounded for inspection due to a hard landing.

According to an example of an embodiment of the present invention, a heuristic algorithm uses multiple airplane parameters to predict load information. The parameters may include sources that describe an internal distribution of forces or strains in materials or structures of the aircraft. The algorithm may be trained using results from an analytical ground-loads simulation. The algorithm may be validated using flight-test data. In addition, if strains are measured during operation of the aircraft, then the algorithm may update itself as the aircraft ages.

One or more embodiments of the present invention may facilitate condition based maintenance. Thus, at least some aircraft maintenance procedures that are presently mandatory and periodic may be based upon need and thus only performed when necessary. This may be accomplished without compromising the safety of the aircraft. Variations of the algorithm described herein may be used to predict in-flight loads which would serve as a detailed load history for the airframe. The load history may then be used to alter the inspection and maintenance intervals resulting in increased revenues.

The heuristic algorithm may be based on derivatives of known mathematical theories. For example, the heuristic algorithm may be based on neural networks or probabilistic neural networks trained with Bayesian regularization.

The proposed hard landing detection system may be used to provide accurate and reliable load information for use in evaluating need and/or level of inspection that is required due to a hard landing event. In this manner, wasteful and unnecessary inspections may be avoided. Further, the scope of some inspections may be reduced to only those items and tests that are actually needed. Thus, both costs and downtime are desirably reduced while safety is maintained.

One or more embodiments of the present invention, such as the system as a whole, may further aid the maintenance process. By providing a more accurate estimation of loads developed during the landing event, the decision to proceed with an appropriate maintenance procedure may be made with enhanced accuracy. Cost savings may be realized by reducing the number of false call inspections resulting from improperly classified landings.

The load estimation algorithm determines approximate loads experienced by selected aircraft structures as a result of load producing events, such as landings. Flight parameter data and optionally sensor information may be recorded during such events. The load estimation algorithm may be executed either immediately following the event or at a later time. The load estimation algorithm may be executed either on board the aircraft or at a location or facility that is remote with respect to the aircraft.

Examples of flight parameters that may be used by the load estimation algorithm include, but are not limited to, pitch angle, roll angle, roll rate, center of gravity (CG) vertical speed, center of gravity (CG) vertical acceleration, airspeed, pilot seat acceleration, and air/ground indication. Examples of sensor information that may be used by the load estimation algorithm include, but are not limited to, strains and accelerations measured at key locations on the aircraft, e.g., on the landing gear, fuselage, nacelle struts, and on other key structural elements affected by hard landings.

In order to maintain desired fidelity, the flight parameters and sensor readings may be recorded with appropriate sample rates so as to accurately resolve the values of parameters that occurred prior to and during landing. It is worthwhile to note that this is generally the only operation that is necessarily performed in real time. Subsequent operations may generally occur off line, e.g., at another time and/or location.

The sampled flight parameters and sensor data may be processed to determine their initial and peak values. This reduced set of sampled data may be used as the input to the load estimation algorithm.

According to one or more embodiments of the present invention, heuristic models are used for load estimation. A heuristic model, such as one using artificial neural networks, may be used to model the complicated phenomena associated with load determination involving multiple inputs and outputs. The heuristic model may be configured so as to act much like a high order nonlinear curve fitting algorithm, such as by relating flight parameters and sensor data to load information.

The heuristic model may be created and/or trained by providing examples of inputs and outputs. Training data sets may be created analytically, e.g., using a numerical simulation, or may be created experimentally, e.g., using flight test data. Training data sets may be created by a combination of both analytical and experimental methods.

Some of the advantages of the use of a heuristic model (as compared to a finite element model, for example) are the ability to model considerably nonlinear phenomena with a fairly compact and efficient set of computations and the automatic handling of the model validation process (which may be extremely challenging, time consuming and costly). Using analytically developed training sets reduces the amount of data required from flight tests, and using judiciously chosen flight test data both validates and increases the accuracy of the algorithm.

Estimated stresses, strains, and/or loads may be used in a variety of ways. For example, all estimated loads may be compared to their threshold values. When one or more of the loads exceeds or approaches its respective threshold value, this would indicate a hard landing and thus the need for inspection. This data may be used in a binary sense such that no actual load information is presented to maintenance personnel. Thus, just a yes or no answer is provided so as to indicate whether or not the aircraft experienced a hard landing. In this manner, the need for an inspection may be determined.

Conversely, detailed information describing loads at a variety of locations around the aircraft may be presented to guide the inspection process. In this manner, some additional details regarding what needs to be inspected and how the inspection is to be performed may be provided.

Load information for many locations on an aircraft (not just the landing gear) may be provided. Thus, better information is available to guide maintenance personnel in both the need for an inspection and regarding what aircraft components are to be inspected.

Using flight parameters reduces the dependence upon strain sensors which have been shown to be less reliable than desired when used to monitor landing gear strains. Thus, reliability is enhanced and the performance of unnecessary inspection is made less likely. The large number of variables involved in a landing event are evaluated in a combined sense that facilitates classification of the landing as either acceptable or hard.

One or more embodiments of the present invention may be implemented completely or partially in software, such as via the use of a general purpose computer. One or more embodiments of the present invention may be implemented in hardware, such as via the use of one or more custom processors.

One or more embodiments of the present invention provide a method and system for detecting hard landings that is cost effective, accurate (i.e., provides minimal false positive and zero false negative hard landing indications), and reliable (i.e., does not solely rely upon measurements from transducers that are non-redundant and/or susceptible to damage). In this manner, less reliance need be placed upon the subjective opinion of the pilot and less downtime of the aircraft is likely to result.

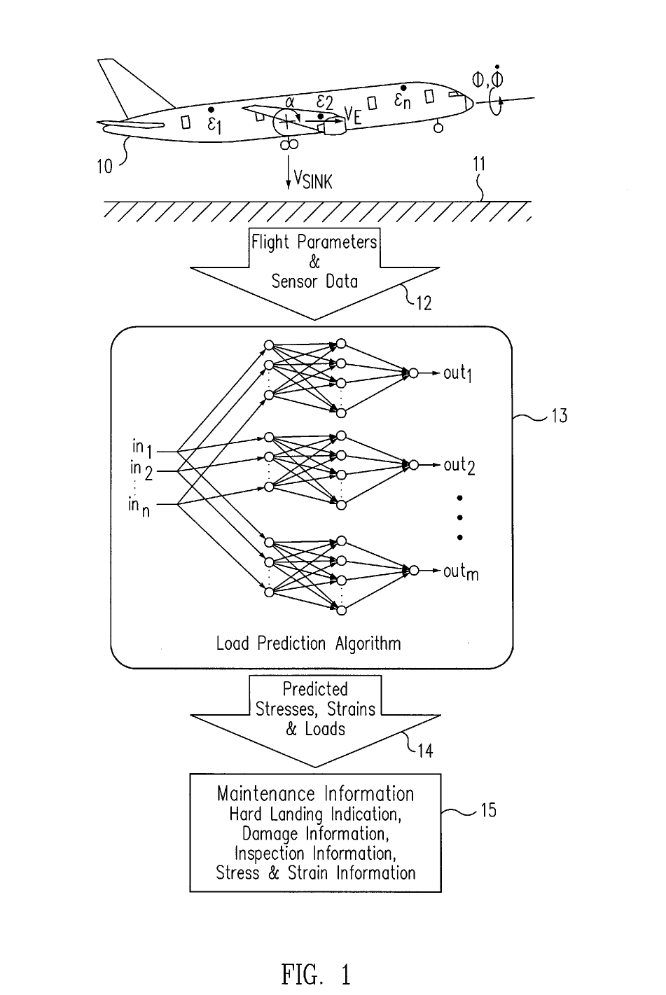

Referring now to FIG. 1, a high level overview of an example of an embodiment of a hard landing detection system of the present invention is shown. An aircraft 10 lands upon a surface, typically a runway 11. Flight parameters and/or sensor data 12 are determined and recorded. For example, pitch angle, roll angle, roll rate, center of gravity (CG) vertical speed, center of gravity (CG) vertical acceleration, airspeed, pilot seat acceleration, and air/ground indication may be determined and recorded.

The heuristic load estimation algorithm (also referred to as a load prediction algorithm) 13 receives at least one, generally a plurality, of inputs. These inputs may comprise flight data and/or sensor data, as described above. These inputs are processed according to an algorithm that has been determined to reliably provide adequately accurate structural load information as outputs. For example, at its simplest the algorithm may comprise one or more lookup tables that correlate flight data and/or sensor data to loads.

As those skilled in the art will appreciate, a heuristic algorithm may generally be trained so as to provide properly known outputs when given corresponding inputs. For example, the heuristic algorithm may be trained using known inputs and outputs derived from experiments using instrumented aircraft. Alternatively, the heuristic algorithm may be trained using results from an analytical ground-loads simulation. The heuristic algorithm may be validated using flight test data. The heuristic algorithm may optionally update itself using strains that are measured during operation of the aircraft.

Estimated or predicted stresses, strains and/or loads 14 are provided by the load estimation program 13. This information may be used, such as by another algorithm, to determine what, if any, inspections and/or maintenance procedures (such as replacement and/or testing of parts) is necessary. Thus, maintenance information 15, such as hard landing indication, damage information, inspection information, and/or stress and strain information is provided to maintenance personnel. In this manner, unnecessary inspections and/or maintenance are mitigated and necessary inspections and/or maintenance are enhanced.

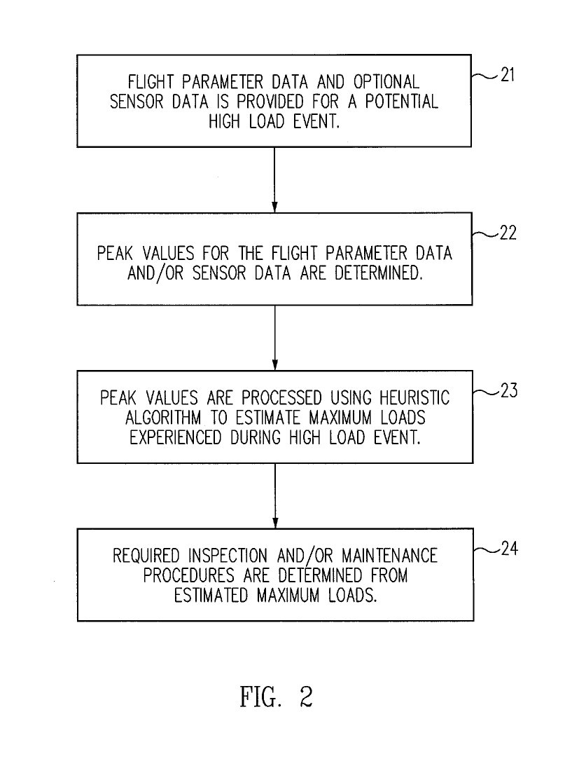

Referring now to FIG. 2, a flow chart shows the method of detecting hard landings according to an exemplary embodiment of the present invention. Flight parameter data is provided when there is a potential high load event, such as a hard landing, as indicated in block 21. Optionally, sensor data (such as from accelerometers, velocity sensors, inclinometers and/or strain gauges) are also provided.

Initial and peak values for the flight parameters and/or sensor data are determined, as indicated in block 22. As those skilled in the art will appreciate, the values of such parameters are generally the most indicative of the peak values of loads experienced by aircraft structures.

The initial and peak values are processed using a heuristic algorithm as indicated in block 23. The heuristic algorithm estimates or predicts the peak loads experienced during the high load event.

Any inspections and/or maintenance procedures that are determined to be necessary as a result of the loads experienced by the aircraft are performed, as indicated in block 24. Use of the present invention tends to provide a better indication of the need for such inspections and maintenance procedures, as compared to the subjective determination of a hard landing by a pilot.

As a simplified example of an embodiment of the present invention, vertical acceleration of the aircraft center of gravity (CG) alone may be used to determine when a hard landing has occurred. Vertical CG acceleration may be derived from flight parameters. The maximum CG acceleration experienced during landing may be used by the heuristic load estimation algorithm to estimate the loads experienced by the aircraft. For example, the load estimation program may use prior flight data to estimate such loads (such as wherein an instrumented aircraft was subjected to various vertical accelerations during test landings and strains were measured on aircraft structures to determine the loads experienced thereby). When loads are greater than a predetermined threshold, then inspections and/or maintenance procedures are indicated.

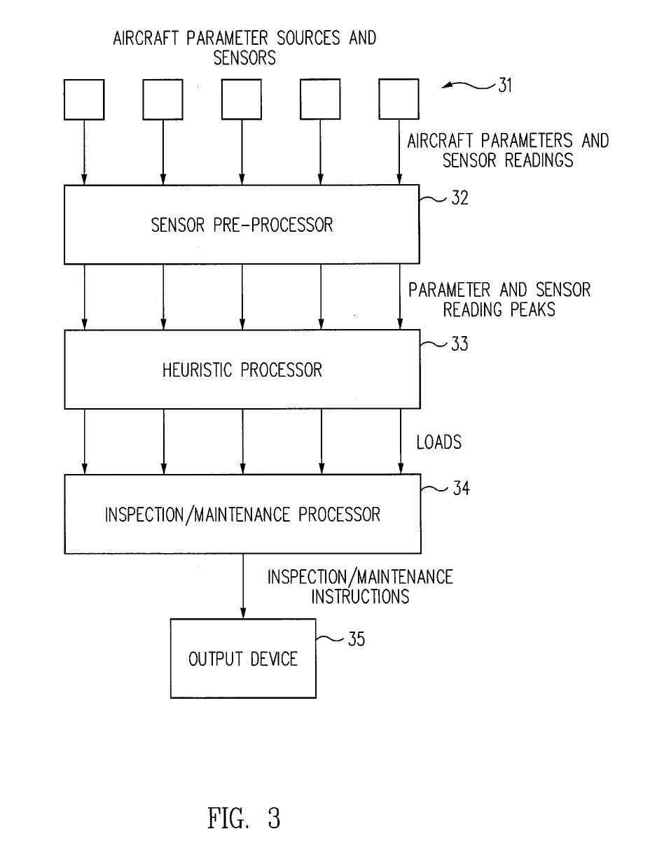

Referring now to FIG. 3, a plurality of aircraft parameter sources and sensors 31 provide aircraft parameters and sensor readings to sensor pre-processor 32. The aircraft parameter sources may include sources of information such as pitch angle, roll angle, roll rate, center of gravity (CG) vertical speed, center of gravity (CG) vertical acceleration, airspeed, pilot seat acceleration, and air/ground indication. The sensors may include accelerometers and strain gauges.

Sensor pre-processor 32 determines the initial and peak values of the aircraft parameters and/or sensor readings. These values are provided to heuristic processor 33. As those skilled in the art will appreciate, the initial and peak values of such data tend to be more representative of potential excessive loads than do other portions of such data.

Heuristic processor 33 uses a heuristic algorithm, as discussed above, to estimate loads, such as loads on key or safety critical aircraft structures. The loads are provided to inspection and maintenance processor 34. Inspection and maintenance processor 34 provides inspection and/or maintenance instructions to an output device 35, such as a monitor or printer. The inspection and/or maintenance instructions may be used by maintenance personnel to perform any inspections and/or maintenance procedures that are required as a result of a hard landing or other load inducing event.

Reference to an aircraft herein is by way of example only and not by way of limitation. Those skilled in the art will appreciate that the methods and systems disclosed herein are likewise applicable to a large variety of other items including non-vehicles (such as buildings, oil rigs, and bridges) and vehicles (such as automobiles, ships, submarines, satellites, and spacecraft).

Hard landings are described herein as examples of load inducing events. One or more embodiments of the present invention may be used to detect when other types of load inducing events have induced loads that exceed a threshold. For example, high load events caused by gusts during flight.

Embodiments described above illustrate but do not limit the invention. It should also be understood that numerous modifications and variations are possible in accordance with the principles of the present invention. Accordingly, the scope of the invention is defined only by the following claims.

We claim:

1. A method for detecting a high load event of an aircraft, the method comprising using a heuristic algorithm to estimate at least one load experienced by the aircraft during the event.

2. The method as recited in claim 1, wherein the heuristic algorithm uses at least one flight parameter to facilitate estimation of the loads(s).

3. The method as recited in claim 1, wherein the heuristic algorithm uses information from at least one sensor to facilitate estimation of the load(s).

4. The method as recited in claim 1, wherein the heuristic algorithm uses information from at least one kinematic source to estimate the load(s).

5. The method as recited in claim 1, wherein the heuristic algorithm uses information from a plurality of kinematic sources to estimate a plurality of loads.

6. The method as recited in claim 1, wherein the heuristic algorithm uses information from at least one kinematic source to estimate a plurality of loads, the kinematic source(s) comprising at least one source that provides information that is representative of an internal distribution of forces in at least one structural element of the aircraft.

7. The method as recited in claim 1, wherein the heuristic algorithm uses information comprising at least one of pitch angle, roll angle, roll rate, vertical speed, vertical acceleration, airspeed, pilot seat acceleration, and air/ground indication to detect a hard landing event.

8. The method as recited in claim 1, wherein the heuristic algorithm uses information comprising at least one of strains and accelerations measured at key locations on the aircraft.

9. The method as recited in claim 1, wherein the heuristic algorithm is trained using results from an analytical loads simulation.

10. The method as recited in claim 1, wherein the heuristic algorithm is validated using test data.

11. The method as recited in claim 1, wherein the heuristic algorithm updates itself using sensors that are measured during operation of the aircraft.

12. The method as recited in claim 1, wherein the heuristic algorithm utilizes neural networks.

13. The method as recited in claim 1, wherein the heuristic algorithm utilizes probabilistic neural networks.

14. The method as recited in claim 1, wherein the heuristic algorithm utilizes Bayesian regularization for training.

15. The method as recited in claim 1, wherein sampled flight parameters and sensor data are processed to estimate their initial and peak values and the heuristic algorithm uses these values to estimate the loads.

16. A system for detecting a high load event of an aircraft, the system comprising:
a sensor pre-processor configured to receive aircraft parameters and to determine initial and peak values thereof; and
a load estimation processor configured to use a heuristic algorithm to estimate loads on aircraft structure from the aircraft parameter initial and peak values.

17. The system as recited in claim 16, wherein the sensor pre-processor is configured to determine the initial and peak values of sensor readings and the load estimation processor is configured to use the heuristic algorithm to estimate loads on aircraft structures using both aircraft parameter and measured sensor readings.

18. The system as recited in claim 16, further comprising a processor for processing the loads so as to determine what aircraft structural elements require inspection and/or maintenance.

19. A system for detecting a high load event of an aircraft
means for determining aircraft parameters;
means for processing the aircraft parameters so as to determine initial and peak values thereof; and
means for processing the initial and peak values using a heuristic algorithm so as to estimate loads experienced during aircraft high load event.

20. The system as recited in claim 19, further comprising means for processing the loads so as to determine what aircraft structural elements require inspection and/or maintenance.
